(19) United States
(12) Patent Application Publication
(10) Pub. No.: US 2023/0268772 A1
(43) Pub. Date: Aug. 24, 2023

(54) Multi-Zone Smart Wireless Charger With Low Battery Indicator

(71) Applicants: DENSO International America, Inc., Southfield, MI (US); DENSO CORPORATION, Kariya-city (JP)

(72) Inventor: Osman AHMED, Bloomfield Hills, MI (US)

(73) Assignees: DENSO International America, Inc., Southfield, MI (US); DENSO CORPORATION, Kariya-city (JP)

(21) Appl. No.: 18/167,178

(22) Filed: Feb. 10, 2023

Related U.S. Application Data
(60) Provisional application No. 63/311,785, filed on Feb. 18, 2022.

(51) Int. Cl. H02J 50/10; H02J 7/00; H02J 50/40

(52) U.S. Cl. CPC H02J 50/10; H02J 7/0048; H02J 50/402

(57) ABSTRACT

Systems and methods of the present disclosure include a base station having multiple charging coils for wirelessly charging a mobile device. A control module activates a first combination of the charging coils and a second combination of the charging coils and monitors electrical characteristics of the charging coils while charging the mobile device. The control module selects a combination of charging coils to continue charging the mobile device based on the monitored electrical characteristics.

### CROSS-REFERENCE TO RELATED APPLICATIONS

This application claims the benefit of U.S. Provisional Application No. 63/311,785, filed on Feb. 18, 2022. The entire disclosure of the above application is incorporated herein by reference.

### FIELD

The present disclosure relates to systems and methods for wireless charging and, more particularly, to systems and methods for wireless charging that include multiple charging zones with multiple charging coils and to systems and methods for wireless charging that include a base station having a low battery indicator.

### BACKGROUND

This section provides background information related to the present disclosure which is not necessarily prior art.

Wireless inductive charging devices can be used to charge a battery of a mobile device, such as a smartphone, smartwatch, or other portable device configured for wireless inductive charging. Larger mobile devices, such as smartphones, generally require charging base stations with larger and higher power coils for inductive charging, while smaller mobile devices, such as smartwatches, generally require charging base stations with smaller and lower power coils. A mismatch between the size and power level of the coils in the charging base stations and the size and power level of the coils in the mobile device can result in inefficient charging and/or in overheating of the mobile device that can result in damage to the mobile device. As such, some users are required to use different types of base stations to charge different types of mobile devices, such as a larger base station for charging smartphones and a smaller base station for charging smartwatches.

### SUMMARY

This section provides a general summary of the disclosure, and is not a comprehensive disclosure of its full scope or all of its features.

The present disclosure includes a system having a base station for wirelessly charging at least one mobile device, the base station including a plurality of charging coils and a control module. The control module is configured to activate at least one first charging coil of the plurality of charging coils to charge the at least one mobile device during a first time period and to monitor at least one electrical characteristic of the at least one first charging coil while charging the at least one mobile device during the first time period. The control module is further configured to activate at least one second charging coil of the plurality of charging coils to charge the at least one mobile device during a second time period and to monitor the at least one electrical characteristic of the at least one second charging coil while charging the at least one mobile device during the second time period. The control module is further configured to compare the at least one electrical characteristic monitored during the first time period with the at least one electrical characteristic monitored during the second time period and to select one of the at least one first charging coil and the at least one second charging coil for charging the at least one mobile device during a third time period after the first and second time periods based on the comparison.

The present disclosure also includes a system having a base station for wirelessly charging at least one mobile device, the base station including a plurality of charging coils, a Bluetooth Low Energy (BLE) communication module, and a control module. The control module is configured to: communicate with the at least one mobile device via the BLE communication module to receive information about the at least one mobile device; select at least one charging coil from the plurality of charging coils based on the received information about the at least one mobile device; and activate the at least one charging coil to charge the at least one mobile device.

The present disclosure also includes a method that includes activating, with a control module of a base station for wirelessly charging at least one mobile device, at least one first charging coil of a plurality of charging coils of the base station to charge the at least one mobile device during a first time period. The method also includes monitoring, with the control module, at least one electrical characteristic of the at least one first charging coil while charging the at least one mobile device during the first time period. The method also includes activating, with the control module, at least one second charging coil of the plurality of charging coils to charge the at least one mobile device during a second time period. The method also includes monitoring, with the control module, the at least one electrical characteristic of the at least one second charging coil while charging the at least one mobile device during the second time period. The method also includes comparing, with the control module, the at least one electrical characteristic monitored during the first time period with the at least one electrical characteristic monitored during the second time period. The method also includes selecting, with the control module, one of the at least one first charging coil and the at least one second charging coil for charging the at least one mobile device during a third time period after the first and second time periods based on the comparison.

The present disclosure also includes another method that includes communicating, using a Bluetooth Low Energy (BLE) communication module of a base station, with at least one mobile device to receive information about the at least one mobile device, the base station including a plurality of charging coils and a control module. The method also includes selecting, with the control module, at least one charging coil from the plurality of charging coils based on the received information about the at least one mobile device. The method also includes activating, with the control module, the at least one charging coil to charge the at least one mobile device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a functional block diagram of multi-zone wireless charging system according to the present disclosure.

FIG. 2 is a functional block diagram of another multi-zone wireless charging system according to the present disclosure.

FIG. 3 is a functional block diagram of another multi-zone wireless charging system according to the present disclosure.

FIG. 4 is a table illustrating switch positions and the resulting charging zones for the multi-zone wireless charging system shown in FIG. 3.

FIG. 5 is a flowchart for multi-zone wireless charging according to the present disclosure.

Corresponding reference numerals indicate corresponding parts throughout the several views of the drawings.

### DETAILED DESCRIPTION

Example embodiments will now be described more fully with reference to the accompanying drawings.

The present disclosure provides systems and methods for multi-zone smart wireless charging utilizing charging base stations that include multiple coils having different sizes. The systems and methods of the present disclosure can be used to charge both a high-power device, such as a smartphone, as well as a low-power device, such as a smartwatch. As described in further detail below, the charging base station of the present disclosure includes multiple charging zones implemented by multiple inductive charging coils. The multiple inductive charging coils can have different sizes. A coil selection device can initially charge a mobile device using different combinations/subsets of the multiple charging coils while monitoring the charging efficiency of each combination/subset of charging coils to identify the most efficient combination/subset of the charging coils for the particular mobile device being charged. The system then utilizes the identified combination/subset of charging coils to efficiently charge the mobile device. In this way, the systems and methods of the present disclosure can customize and identify the most efficient combination/subset of charging coils in the charging base station to charge a mobile device. Further, the systems and methods of present disclosure can beneficially avoid issues, such as overheating, resulting from a mismatch between the size and power level of the inductive charging coils used in the charging base station and the size and power level of the inductive charging coils in the mobile device to be charged.

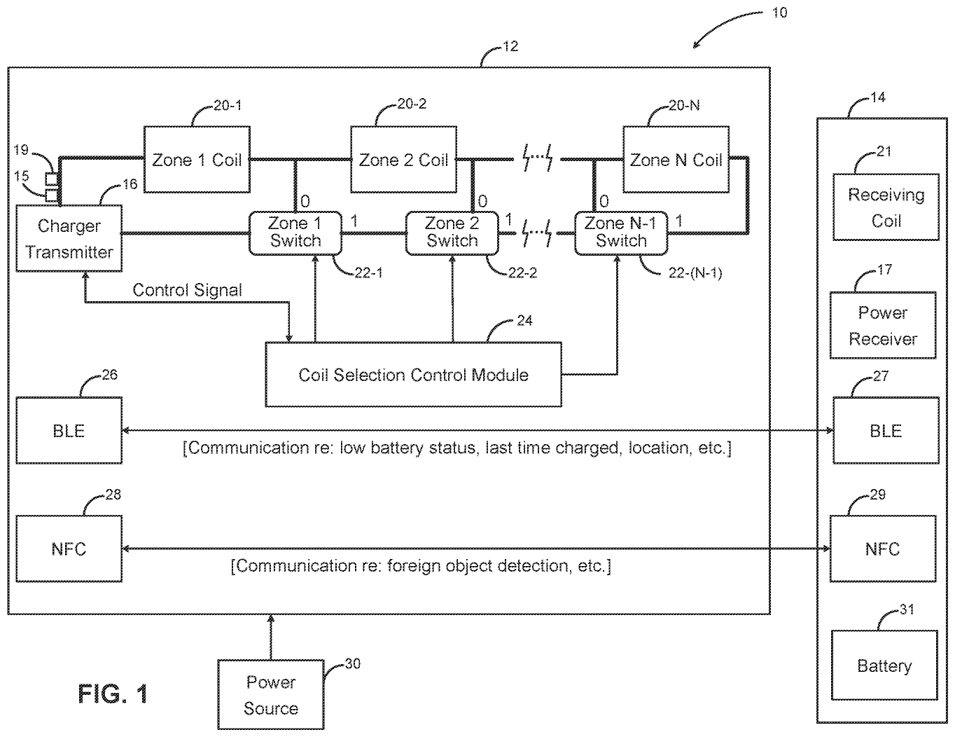

With reference to FIG. 1, a multi-zone smart wireless charging system 10 is shown and includes a charging base station 12 and a mobile device 14 to be charged by the base station 12. The mobile device 14 can include, for example, a smartphone, a smartwatch, a key fob for a vehicle, or other portable device configured for wireless inductive charging. In addition, while a single mobile device 14 is shown in FIG. 1, multiple mobile devices 14 can be simultaneously charging using the base station 12 in accordance with the present disclosure. For example, a smartphone and a key fob can be simultaneously charged, a smartwatch and a key fob can be simultaneously charged, a smartphone and a smartwatch can be simultaneously charged, and all of a smartphone, a smartwatch, and a key fob can be simultaneously charged using the base station 12 in accordance with the present disclosure. The base station 12 can be located, for example, in a building or in a vehicle. The multi-zone smart wireless charging system 10 can provide wireless inductive charging based on, for example, the Qi standard for wireless power transfer. The present teachings, however, can alternatively utilize another suitable standard or protocol for wireless inductive charging.

As shown in FIG. 1, the base station 12 includes multiple inductive charging coils 20-1, 20-2, . . . 20-N, collectively referred to as charging coils 20. The charging coils 20 can have different sizes to provide different power levels of charging. The charging coils 20 of the base station 12 are also referred to as transmitting coils and are driven by a charger transmitter 16, which can also be referred to as a charger integrated circuit (IC) transmitter. The charger transmitter 16 is connected to and receives power from a power source 30 connected to the base station 12. The power source 30 can be, for example, an AC power outlet of a building or a battery of a vehicle. To charge the mobile device 14, the mobile device 14 is placed in proximity to the base station 12 and the charging coils 20 of the base station 12 are driven by the charger transmitter 16 to generate an oscillating magnetic field. For example, the base station 12 may be a charging pad located in a building or a charging pad integrated into a console of a vehicle. The mobile device 14 includes a receiving coil 21, which can also be referred to as target coil, and a power receiver 17, which can also be referred to as a target IC receiver. The oscillating magnetic field generated by the charging coils 20 of the base station 12 induces an alternating current in the receiving coil 21 that is used by the power receiver 17 to charge a battery 31 of the mobile device 14.

The base station 12 includes (N−1) switches 22-1, 22-2, . . . 22-(N−1), collectively referred to as switches 22. In other words, the base station 12 can include a number of switches 22 that is one less than the number charging coils 20. The base station 12 also includes a coil selection control module 24 that controls the switches 22 to activate different combinations/subsets of the charging coils 20, as discussed in further detail below. The coil selection control module 24 is in communication with the charger transmitter 16. The coil selection control module 24 can be implemented by, for example, a controller, a microcomputer, a processor and memory that stores code executed by the processor, or another suitable computing device or suitable circuitry configured to implement and perform the functionality of the coil selection control module 24, as described in further detail below. While N charging coils 20 and N−1 switches 22 are shown in FIG. 1, any number of charging coils 20, such as 2, 3, or 4 charging coils 20, with a suitable number of switches, such as 1, 2, or 3 switches 22, can be used in accordance with the present teachings. The dots and angles lines between zone 2 coil 20-2 and zone N coil 20-N and between zone 2 switch 22-2 and zone N−1 switch 22-(N−1) indicate that additional charging coils 20 and additional switches 22 could be included in the base station 12. Throughout the figures, the thicker black lines are used to illustrate electrical paths, such as wires, that carry electrical voltage and current between the charger transmitter 16, the charging coils 20, and the switches 22, while the thinner black lines are used to illustrate control and communication paths for communication between components of the multi-zone smart wireless charging system 10.

The coil selection control module 24 determines an optimal subset of charging coils 20 to be used for wireless charging of the mobile device 4 and controls the switches 22 to activate the determined optimal subset of charging coils 20, as discussed in further detail below. In the example of FIG. 1, the coil selection control module 24 can control the zone 1 switch 22-1 to connect the charger transmitter 16 to a point between the zone 1 coil 20-1 and the zone 2 coil 20-2. In FIG. 1, 1s and 0s are shown to illustrate the two different positions of each of the switches 22 and the resulting connection points for each of the switches 22 of FIG. 1. For example, the zone 1 switch 22-1 connects the charger transmitter 16 to the point between the zone 1 coil 20-1 and the zone 2 coil 20-2 while in the 0 position and to the zone 2 switch 22-2 while in the 1 position. In this way, when the zone 1 switch 22-1 is in the 0 position, only the zone 1 coil 20-1 will be activated and used for wireless charging. Similarly, to activate both the zone 1 coil 20-1 and the zone 2 coil 20-2, the coil selection control module 24 can control the zone 1 switch 22-1 to the 1 position to connect the charger transmitter 16 to the zone 2 switch 22-2 and can control the zone 2 switch 22-2 to the 0 position to connect the zone 2 switch 22-2 to a point between the zone 2 coil 20-2 and the zone N coil 20-N. In this way, both the zone 1 coil 20-1 and the zone 2 coil 20-2, and only the zone 1 coil 20-1 and the zone 2 coil 20-2, will be activated and used for wireless charging. Similarly, to activate all of the coils 20, the coil selection control module 24 can control the zone 1 switch 22-1 to the 1 position to connect the charger transmitter 16 to the zone 2 switch 22-2 and can control the zone 2 switch 22-2 to the 1 position to connect the zone 1 switch 22-1 to the zone N coil 20-N. In addition, the coil selection control module 24 can control the zone N−1 switch to the 1 position, as well as any switches between the zone 2 switch 22-2 and the zone N−1 switch 22-(N−1), to connect the zone N−1 switch 22-(N−1) to the zone N coil 20-N. In this way, all of the coils 20 will be activated and used for wireless charging. In other words, when all of the charging coils 20 are used, a current path will be created from the charger transmitter 16 to the zone 1 coil 20-1 to the zone 2 coil 20-2, to any additional charging coils 20 between the zone 2 coil 20-2 and the zone N coil 20-N, to the zone N coil 20-N, to the zone N−1 switch 22-(N−1), to any switches between the zone N−1 switch 22-(N−1) and the zone 2 switch 22-2, to zone 2 switch 22-2, to zone 1 switch 22-1, and back to the charger transmitter 16.

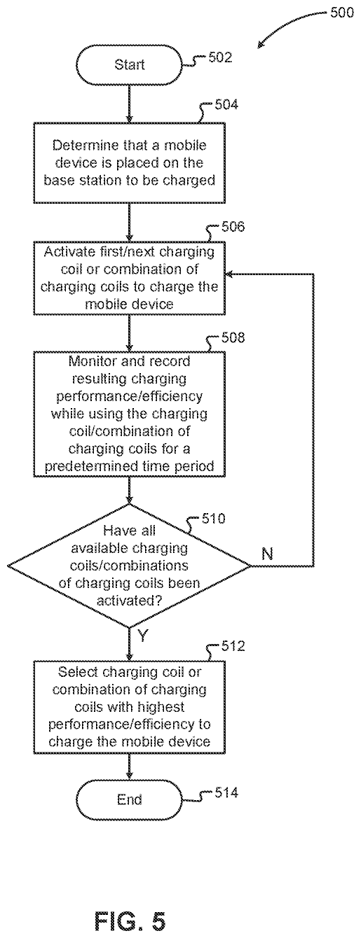

The charging coils 20 can be differently sized to provide different power levels of charging for different sizes and types of devices to be charged. For example, the zone 1 coil 20-1 may be a smallest coil and can be used to charge a key fob device. The zone 2 coil 20-2 may be similarly sized or slightly larger coil such that using the zone 1 coil 20-1 and the zone 2 coil 20-2 together can charge a medium sized device, such as a smartwatch. Using all of the charging coils 20 together can charge a larger device, such as a smartphone or tablet device. As discussed in further detail below with reference, for example, to FIG. 5, the coil selection control module 24 can activate different subsets of the charging coils 20 and monitor electrical characteristics of the resulting charging activity to determine the most efficient subset or combination of charging coils 20 to use for charging the particular mobile device 14 being charged. For example, the base station 12 can include one or more electrical sensors to sense electrical characteristics of the electrical power being provided by the charger transmitter 16 to one or more of the charging cols 20. For example, the one or more electrical sensors can include a voltage sensor 15 that senses a voltage being provided by the charger transmitter 16 to one or more of the charging coils 20. Additionally or alternatively, the one or more electrical sensors can include a current sensor 19 that senses a current being provided by the charger transmitter 16 to one or more of the charging coils 20. The electrical sensors, such as the voltage sensor 15 and/or the current sensor 19, can be in direct communication with eh coil selection control module 24 or, alternatively, can be in communication with, or part of, the charger transmitter 16, that can communicate the electrical characteristics, such as the sensed current and/or voltage, to the coil selection control module. Additionally or alternatively, while a voltage sensor 15 and a current sensor 19 are shown in FIG. 1, a power sensor can also be used to sense an amount of electrical power being provided by the charger transmitter 16 to the charging coils 20.

Additionally or alternatively, multiple mobile devices 14 can be charged at the same time and the base station 12 and coil selection control module 24 can determine the most efficient subset or combination of charging coils 20 to use to charge the multiple mobile devices 14 being simultaneously charged with the base station 12 based on the electrical characteristics of the electrical power being provided by the charger transmitter 16 to the charging coils 20.

The base station 12 and the mobile device 14 can be configured to wirelessly communicate using Bluetooth or the Bluetooth Low Energy (BLE) communication protocols, or another suitable wireless communication protocol, as discussed in further detail below. For example, the base station 12 can include a BLE module 26 configured to communicate with a BLE module 27 of the mobile device 24. As shown in FIG. 1, the BLE module 26 of the base station 12 can communicate with the BLE module 27 of the mobile device 14 to determine a low battery status of the mobile device 14 or information regarding the last time the battery 31 of the mobile device 14 was charged. While smartphones and smartwatches generally include output devices to directly communicate information regarding the battery of the device to a user, other devices, such as a key fob for a vehicle, do not generally include output functionality to communicate such information to a user. In this way, the BLE module 26 of the base station 12 can communicate with the BLE module 27 of the mobile device 14 to receive information about the status and health of the battery 31 of the mobile device 14 and can then communicate that information to a user of the mobile device 14. For example, if the base station 12 is located in a vehicle, the base station 12 can use the user interface, such as an infotainment center or display console, to output information about the mobile device 14, such as a key fob of the vehicle, to a user. For example, the information could indicate that the battery 31 of the key fob has a low charge and should be charged for an extended period of time or indicate that the battery 31 of the key fob has not been holding a charge well and should be replaced soon. Additionally or alternatively, the base station 12 can communicate such information about the battery of the key fob, for example, to a user interface of another mobile device being charged by the base station 12, such as a smartphone or smartwatch. In this way, the user can receive an alert on their smartphone or smartwatch being charged by the base station 12 indicating the battery health of their key fob also being charged on the base station. For example, the information can indicate that the battery of the key fob has not been holding a charge and should be replaced soon.

In addition, the base station 12 can use BLE to determine a location of the mobile device 14. For example, the base station 12 can use the BLE module 26 to communicate with the BLE module 27 of the mobile device 14. The base station 12 can measure a signal strength of signals received by the BLE module 26 from the BLE module 27 of the mobile device and determine a received signal strength indicator (RSSI) of the received signals. Based on the RSSI of the received signals, the base station 12 can estimate a location or distance of the mobile device 14 from the base station 12 and can communicate the location or distance of the mobile device 14 to a user of the mobile device 12. For example, if the base station 12 is located in a vehicle, the base station 12 can use a user interface, such as an infotainment center or display console, to output information about the location or distance of the mobile device 14 to the user.

Additionally or alternatively, the base station 12 can communicate with the mobile device 14 using near-field communication (NFC). For example, the base station 12 can include an NFC module 28 for communication with an NFC module 29 of the mobile device 14. The NFC module 28 of the base station 12 can also communicate with other devices configured for communication via the NFC protocol. In particular, the base station 12 can use NFC to perform foreign object detection and determine that a foreign object near the base station 12 is not an object that can be charged and can take action to prohibit activation of the charging coils 20 to avoid potential damage to the foreign object. For example, the foreign object can be a credit card with an NFC chip configured for communication using NFC. In particular, a user may keep a credit card with an NFC chip near or with the user's smartphone, such as in a compartment of a case of the user's smartphone. In such case, if the credit card and smartphone are placed near the base station 12, the base station 12 can determine that the smartphone can be charged using wireless charging. The base station 12, however, may communicate using NFC and the NFC module 28 with the NFC chip of the credit card to determine that the credit card is near the base station 12. In such case, the base station 12, upon detecting the credit card, may prohibit wireless inductive charging of the smartphone to avoid damage to the NFC chip of the credit card that could result from the NFC chip of the credit card being near the charging coils 20 of the base station 12 during charging of the smartphone.

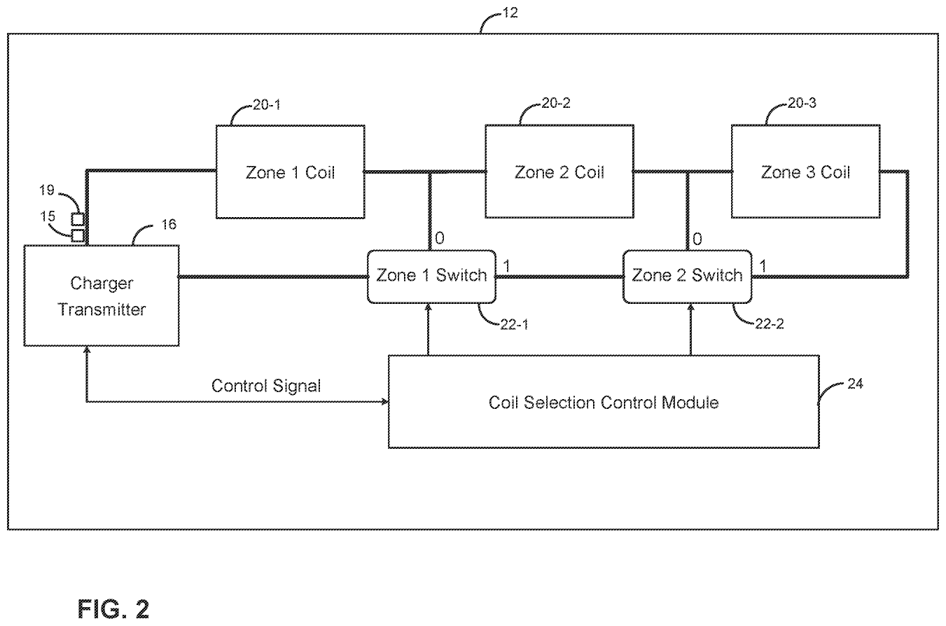

With reference to FIG. 2, a specific configuration of the base station 12 shown in FIG. 1 is shown and includes three charging coils 20-1, 20-2, and 20-3 and two switches 22-1 and 22-2. The coil selection control module 24 can control the switches 22 to selectively connect the coils 20 to the charger transmitter 16. In the configuration of FIG. 2, the coil selection control module 24 can control the switches 22 to activate the coils 20 in one of the following combinations: no coils activated; only zone 1 coil 20-1 activated; both, and only, zone 1 coil 20-1 and zone 2 coil 20-2 activated; and all three charging coils, i.e., zone 1 coil 20-1, zone 2 coil 20-2, and zone 3 coil 20-3, activated. In the configuration of FIG. 2, the coil selection control module 24 can control the zone 1 switch 22-1 to the 0 position to connect the charger transmitter 16 to a point between the zone 1 coil 20-1 and the zone 2 coil 20-2. In this way, only the zone 1 coil 20-1 will be activated and used for wireless charging. Similarly, to activate both the zone 1 coil 20-1 and the zone 2 coil 20-2 together, the coil selection control module 24 can control the zone 1 switch 22-1 to the 1 position to connect the charger transmitter 16 to the zone 2 switch 22-2 and can control the zone 2 switch 22-2 to the 0 position to connect the zone 1 switch 22-1 to a point between the zone 2 coil 20-2 and the zone 3 coil 20-03. In this way, only the zone 1 coil 20-1 and the zone 2 coil 20-2 will be activated and used for wireless charging. Similarly, to activate all of the coils 20, the coil selection control module 24 can control the zone 1 switch 22-1 to the 1 position to connect the charger transmitter 16 to the zone 2 switch 22-2 and can control the zone 2 switch 22-2 to the 1 position to connect the zone 1 switch 22-1 to the zone 3 coil 20-3. In this way, all three of the coils 20 will be activated and used for wireless charging. As discussed in detail above with reference to FIG. 1, the coil selection control module 24 can monitor electrical characteristics of the electrical power being supplied by the charger transmitter 16 to the charging coils 20 using the electrical sensors, such as the voltage sensor 15, the current sensor 19, and/or a power sensor, and can determine and select the most efficient subset or combination of charging coils 20 to use for charging a particular mobile device 14 being charged.

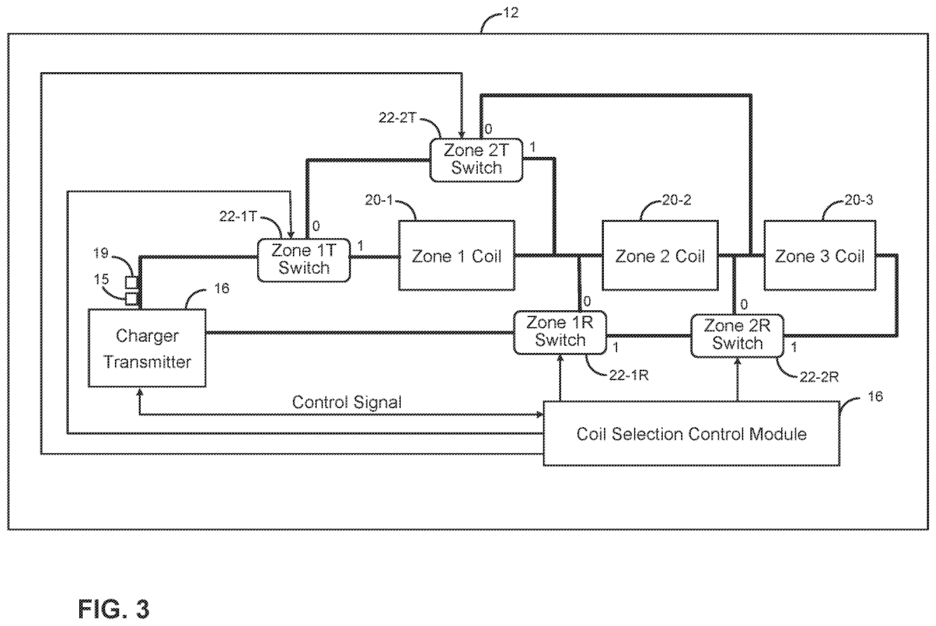

With reference to FIG. 3, another embodiment of the base station 12 is shown. In the configuration of FIG. 3, the base station 12 includes three charging coils, zone 1 coil 20-1, zone 2 coil 20-2, and zone 3 coil 20-3, and four switches denoted as zone 1R switch 22-1R, zone 2R switch 22-2R, zone 1T switch 22-1T, and zone 2T switch 22-2T. In the configuration of FIG. 3, the coil selection control module 16 can control the switches 22 to activate multiple different combinations of the charging coils. In FIG. 3, similar to FIGS. 1 and 2, a “1” and a “0” are shown to illustrate the two different positions of each of the switches 22 and the resulting connection points for each of the two positions of the four switches 22. For example, the zone 1T switch 22-1T connects the charger transmitter 16 to the zone 2T switch 22-2T while in the 0 position and to the zone 1 coil 20-1 while in the 1 position. The zone 2T switch 22-2T connects the zone 1T switch 22-1T to a point between the zone 2 coil 20-2 and the zone 3 coil 20-3 while in the 0 position and to a point between the zone 1 coil 20-1 and the zone 2 coil 20-2 while in the 1 position. The zone 1R switch 22-1R connects the charger transmitter 16 to a point between the zone 1 coil 20-1 and the zone 2 coil 20-2 while in the 0 position and to the zone 2R switch 22-R while in the 1 position. The zone 2R switch 22-2R connects the zone 1R switch 22-1R to a point between the zone 2 coil 20-2 and the zone 3 coil 20-3 while in the 0 position and to the zone 3 coil 20-3 while in the 1 position.

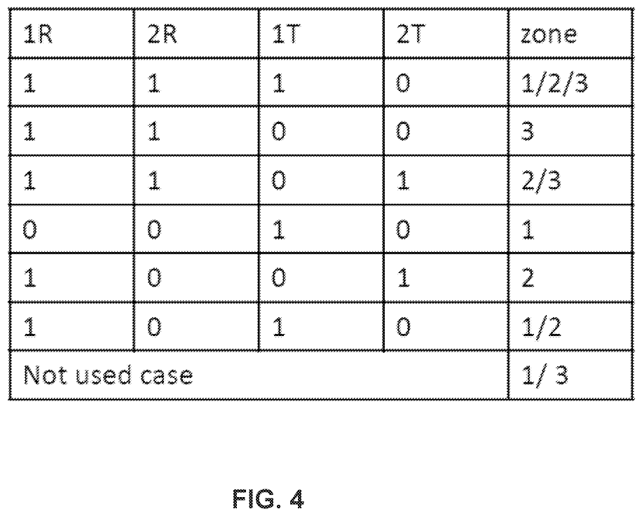

With the configuration of FIG. 3, the coil selection control module 16 can control the switches 22 to activate any combination of the charging coils 20. For example, FIG. 4 shows a chart illustrating the various combinations of switch positions for the switches 22 and the resulting zones or coils 20 that are activated by the various combinations.

For example, to activate a combination of the zone 1 coil 20-1, the zone 2 coil 20-2, and the zone 3 coil 20-3, the coil selection control module 16 controls the switches into the following positions: zone 1R switch 22-1R to the 1 position; zone 2R switch 22-2R to the 1 position; zone 1T switch 22-1T to the 1 position; and zone 2T switch 22-2T to the 0 position.

To activate only the zone 3 coil 20-3, the coil selection control module 16 controls the switches into the following positions: zone 1R switch 22-1R to the 1 position; zone 2R switch 22-2R to the 1 position; zone 1T switch 22-1T to the 0 position; and zone 2T switch 22-2T to the 0 position.

To activate a combination of only the zone 2 coil 20-2 and the zone 3 coil 20-3, the coil selection control module 16 controls the switches into the following positions: zone 1R switch 22-1R to the 1 position; zone 2R switch 22-2R to the 1 position; zone 1T switch 22-1T to the 0 position; and zone 2T switch 22-2T to the 1 position.

To activate only the zone 1 coil 20-1, the coil selection control module 16 controls the switches into the following positions: zone 1R switch 22-1R to the 0 position; zone 2R switch 22-2R to the 0 position; zone 1T switch 22-1T to the 1 position; and zone 2T switch 22-2T to the 0 position.

To activate only the zone 2 coil 20-2, the coil selection control module 16 controls the switches into the following positions: zone 1R switch 22-1R to the 1 position; zone 2R switch 22-2R to the 0 position; zone 1T switch 22-1T to the 0 position; and zone 2T switch 22-2T to the 1 position.

To activate a combination of only the zone 1 coil 20-1 and the zone 2 coil 20-2, the coil selection control module 16 controls the switches into the following positions: zone 1R switch 22-1R to the 1 position; zone 2R switch 22-2R to the 0 position; zone 1T switch 22-1T to the 1 position; and zone 2T switch 22-2T to the 0 position.

While FIG. 3 illustrates an embodiment of the base station 12 with switches 22 that can be used to activate any combination of the coils (except for the combination of the zone 1 coil 20-1 with the zone 3 coil 20-3), in other embodiments the switches 22 and the coil selection control module 16 can be used to activate all possible combinations of the coils 20 for charging.

With reference to FIG. 5, a flowchart is shown illustrating a method 500 of selecting a charging coil 20 or combination of charging coils to charge a mobile device 14 is shown. The method 500 can be executed by the base station 12 and, more specifically, the coil selection control module 16 of the base station 12. Alternatively, the base station 12 can include a separate processor, module, or circuitry, in addition to the coil selection control module 16, and in communication with the coil selection control module 16 and/or the charger transmitter 16, that is configured to perform the functionality illustrated in FIG. 5. The method 500 starts at 502. At 504, the coil selection control module 16 determines that a mobile device 14 has been placed on the base station to be charged. For example, the base station 12 and the mobile device 14 can communicate and initiate the charging process in accordance with the Qi standard for wireless power transfer.

At steps 506 to 510, the coil selection control module 16 sequentially activates all available charging coils 20 and combinations of charging coils 20 and monitors the resulting performance/efficiency of the wireless charging. For example, at 506, the coil selection control module 16 activates a first available charging coil 20 or combination of charging coils 20 and charges the mobile device 14 using the activated charging coil or combination of charging coils 20 for a predetermined time period. At 508, the coil selection control module 16 monitors and records the resulting charging performance/efficiency while using the current charging coil 20 or combination of charging coils 20. For example, the coil selection control module 16 can monitor the voltage and/or current being supplied by the charger transmitter 16, based on the voltage and/or current sensed by the voltage sensor 15 and/or the current sensor 19, to determine the amount of charging being provided to the mobile device 14 by the current charging coil 20 or combination of charging coils 20. As mentioned above, additionally or alternatively, a power sensor can also be used to sense an amount of electrical power being provided to the mobile device 14 by the current charging coil 20 or combination of charging coils 20.

Once the base station 12 has charged the mobile device 14 using the current charging coil 20 or combination of charging coils 20 for the predetermined time period and recorded the resulting charging performance/efficiency, the coil selection control module 16 proceeds to 510 and determines whether all available charging coils 20 combinations of charging coils 20 have been activated and used to charge the mobile device 14. When additional charging coils 20 or combinations of charging coils 20 remain available, the coil selection control module 16 loops back to 506 and activates the next available charging coil 20 or combination of charging coils 20. The coil selection control module 16 proceeds in this manner until all available charging coils 20 or combinations of charging coils 20 have been used to charge the mobile device 14 for the predetermined time period. The coil selection control module 16 then proceeds to 512.

At 512, the coil selection control module 16 reviews the resulting performance/efficiency of charging for each charging coil 20 and combination of charging coils 20 and selects the charging coil 20 or combination of charging coils 20 that resulted in the highest/best performance/efficiency for charging the mobile device 14 during the predetermined period. The coil selection control module 16 then activates the selected charging coil 20 or combination of charging coils 20 and proceeds with charging the mobile device 14 to completion or until the mobile device 14 is removed from the base stations 12. The method 500 ends at 514.

In this way, the base station 12 and the coil selection control module 16 are able to select the charging coil 20 or combination of charging coils 20 that most efficiently charge the mobile device 14. In this way, different sizes and types of mobile devices 14 can be charged with the base station 12, such as smartphones, smartwatches, and key fobs, and, in each case, the base station 12 and coil selection control module 16 can automatically select the best and most efficient charging coil 20 or combination of charging coils 20 to charge the particular mobile device 14 being charged. As a result, the base station 12 and the coil selection control module 16 are beneficially able to automatically select the charging coil 20 or combination of charging coils 20 that are most appropriately sized for the particular mobile device 14 being charged.

Additionally or alternatively, the base station 12 can also be configured to communicate with the mobile 12 to determine the type or size of mobile device 14 to be charged and/or the type or size of battery 31 included in the mobile device 14 to be charged. In this way, instead of performing the method of FIG. 5, the base station 12 and coil selection control module 16 can determine the type or size of mobile device 14 and automatically select the appropriate charging coil 20 or combination of charging coils 20 based on the determined type or size of the mobile device 14 and/or the type or size of the battery 31 of the mobile device 14. For example, the base station 12 can communicate with the mobile device 14 using BLE modules 26, 27 and/or by using the NFC modules 28, 29 to determine the type or size of the mobile device 14 and/or the type or size of the battery 31 of the mobile device 14. The base station 12 can store, for example, a lookup table in a memory accessible to the base station 12 and/or the coil selection control module 16 that stores designated charging coils 20 or combinations of charging coils 20 for different types or sizes of mobile device and/or different types or sizes of batteries 31 of the mobile device 14. In this way, the base station 12 and/or the coil selection control module 16 can quickly determine the type or size of mobile device 12 and/or battery 31 to be charged, reference the lookup table to determine the particular charging coil 20 or combination of charging coils 20 to use for charging. Additionally or alternatively, the base station 12 and/or the coil selection control module 16 can determine the type or size of the mobile device 12 and/or battery 31 to be charged and an estimated amount of charging needed to be provided to charge the battery 31 of the mobile device 12, and select a particular charging coil 20 or combination of charging coils 20 based on the estimated amount of charging needed. For example, when the base station 12 and/or the coil selection control module 16 determine that a large mobile device 14 or battery 31 is to be charged and that a relatively large amount of charging is needed, the base station 12 and/or the coil selection control module 16 may activate all available charging coils 20 to charge the mobile device 14. Similarly, when the base station 12 and/or the coil selection control module 16 determine that a small mobile device 14 or battery 31 is to be charged and that only a relatively small amount of charging is needed, the base station 12 and/or the coil selection control module 16 may activate only a smallest charging coil 20 of the available charging coils 20 to charge the mobile device 14.

In this way, the systems and methods of the present disclosure can efficiently charge different sizes and types of mobile devices 14 while avoiding overheating of the mobile device 14 and/or the base station 12. In this way, the systems and methods of the present disclosure provide improved charging performance and stability and avoid the mobile device 14 and/or the base station 12 being shutdown due to thermal overheating. Additionally, the systems and methods of the present disclosure beneficially provide a single charging system and base station 12 that can be used to charge multiple different sizes and types of mobile devices 14 without requiring the user to purchase multiple different charging devices for multiple different mobile devices 14, such as a smartphone, smartwatch, and key fob.

The present disclosure includes a system having a base station for wirelessly charging at least one mobile device. The base station includes a plurality of charging coils and a control module configured to: activate at least one first charging coil of the plurality of charging coils to charge the at least one mobile device during a first time period; monitor at least one electrical characteristic of the at least one first charging coil while charging the at least one mobile device during the first time period; activate at least one second charging coil of the plurality of charging coils to charge the at least one mobile device during a second time period; monitor the at least one electrical characteristic of the at least one second charging coil while charging the at least one mobile device during the second time period; compare the at least one electrical characteristic monitored during the first time period with the at least one electrical characteristic monitored during the second time period; and select one of the at least one first charging coil and the at least one second charging coil for charging the at least one mobile device during a third time period after the first and second time periods based on the comparison.

The at least one mobile device can include a key fob.

The at least one mobile device can include at least one of a smartphone and a smartwatch.

The base station can be configured to simultaneously charge a key fob and at least one of a smartphone and a smartwatch.

The base station can be configured to simultaneously charge each of a smartphone and a smartwatch.

The base station can further include a Bluetooth Low Energy (BLE) module to communicate with the at least one mobile device using BLE to receive information about at least one battery of the at least one mobile device and to output the information about the at least one battery of the at least one mobile device.

The base station can be located in a vehicle and can be configured to output the information about the at least one battery of the at least one mobile device to a display screen of the vehicle.

The information about the at least one battery of the at least one mobile device can include at least one of a low battery status and a last time the battery was charged.

The base station can be configured to determine at least one of a location and a distance of one of the at least one mobile device to the base station based on signal strength of BLE signals received from the one of the at least one mobile device.

The base station can further include a near-field communication (NFC) module to communicate with a NFC enabled device to prohibit charging the at least one mobile device in response to the NFC enabled device communicating with the NFC module of the base station.

The present disclosure also includes a system having a base station for wirelessly charging at least one mobile device. The base station includes a plurality of charging coils, a Bluetooth Low Energy (BLE) communication module, and a control module configured to: communicate with the at least one mobile device via the BLE communication module to receive information about the at least one mobile device; select at least one charging coil from the plurality of charging coils based on the received information about the at least one mobile device; and activate the at least one charging coil to charge the at least one mobile device.

The control module can be further configured to receive information about at least one battery of the at least one mobile device via communication with the at least one mobile device and to output the information about the at least one battery of the at least one mobile device.

The base station can be located in a vehicle be configured to output the information about the at least one battery of the at least one mobile device to a display screen of the vehicle.

The information about the at least one battery of the at least one mobile device can include at least one of a low battery status and a last time the battery was charged.

The present disclosure also includes a method that includes activating, with a control module of a base station for wirelessly charging at least one mobile device, at least one first charging coil of a plurality of charging coils of the base station to charge the at least one mobile device during a first time period and monitoring, with the control module, at least one electrical characteristic of the at least one first charging coil while charging the at least one mobile device during the first time period. The method also includes activating, with the control module, at least one second charging coil of the plurality of charging coils to charge the at least one mobile device during a second time period and monitoring, with the control module, the at least one electrical characteristic of the at least one second charging coil while charging the at least one mobile device during the second time period. The method also includes comparing, with the control module, the at least one electrical characteristic monitored during the first time period with the at least one electrical characteristic monitored during the second time period and selecting, with the control module, one of the at least one first charging coil and the at least one second charging coil for charging the at least one mobile device during a third time period after the first and second time periods based on the comparison.

The at least one mobile device can include a key fob.

The at least one mobile device can include at least one of a smartphone and a smartwatch.

The base station can be configured to simultaneously charge a key fob and at least one of a smartphone and a smartwatch.

The base station can be configured to simultaneously charge each of a smartphone and a smartwatch.

The base station can further include a Bluetooth Low Energy (BLE) module to communicate with the at least one mobile device using BLE to receive information about at least one battery of the at least one mobile device and to output the information about the at least one battery of the at least one mobile device.

The base station can be located in a vehicle and be configured to output the information about the at least one battery of the at least one mobile device to a display screen of the vehicle.

The information about the at least one battery of the at least one mobile device can include at least one of a low battery status and a last time the battery was charged.

The method can further include determining at least one of a location and a distance of the one of the at least one mobile device to the base station based on signal strength of BLE signals received from the one of the at least one mobile device.

The base station can further include a near-field communication (NFC) module to communicate with a NFC enabled device to prohibit charging the at least one mobile device in response to the NFC enabled device communicating with the NFC module of the base station.

The present disclosure also includes a method that includes communicating, using a Bluetooth Low Energy (BLE) communication module of a base station, with at least one mobile device to receive information about the at least one mobile device, the base station including a plurality of charging coils and a control module. The method also includes selecting, with the control module, at least one charging coil from the plurality of charging coils based on the received information about the at least one mobile device. The method also includes activating, with the control module, the at least one charging coil to charge the at least one mobile device.

The control module can be further configured to receive information about at least one battery of the at least one mobile device via communication with the at least one mobile device and to output the information about the at least one battery of the at least one mobile device.

The base station can be located in a vehicle and can be configured to output the information about the at least one battery of the at least one mobile device to a display screen of the vehicle.

The information about the at least one battery of the at least one mobile device can include at least one of a low battery status and a last time the battery was charged.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

The module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough, and will fully convey the scope to those who are skilled in the art.

What is claimed is:

1. A system comprising:
a base station for wirelessly charging at least one mobile device, the base station including a plurality of charging coils and a control module configured to:
activate at least one first charging coil of the plurality of charging coils to charge the at least one mobile device during a first time period;
monitor at least one electrical characteristic of the at least one first charging coil while charging the at least one mobile device during the first time period;
activate at least one second charging coil of the plurality of charging coils to charge the at least one mobile device during a second time period;
monitor the at least one electrical characteristic of the at least one second charging coil while charging the at least one mobile device during the second time period;
compare the at least one electrical characteristic monitored during the first time period with the at least one electrical characteristic monitored during the second time period; and
select one of the at least one first charging coil and the at least one second charging coil for charging the at least one mobile device during a third time period after the first and second time periods based on the comparison.

2. The system of claim 1, wherein the at least one mobile device includes a key fob.

3. The system of claim 1, wherein the at least one mobile device includes at least one of a smartphone and a smartwatch.

4. The system of claim 1, wherein the base station is configured to simultaneously charge a key fob and at least one of a smartphone and a smartwatch.

5. The system of claim 1, wherein the base station is configured to simultaneously charge each of a smartphone and a smartwatch.

6. The system of claim 1, wherein the base station further includes a Bluetooth Low Energy (BLE) module to communicate with the at least one mobile device using BLE to receive information about at least one battery of the at least one mobile device and to output the information about the at least one battery of the at least one mobile device.

7. The system of claim 6, wherein the base station is located in a vehicle and the base station is configured to output the information about the at least one battery of the at least one mobile device to a display screen of the vehicle.

8. The system of claim 6, wherein the information about the at least one battery of the at least one mobile device includes at least one of a low battery status and a last time the battery was charged.

9. The system of claim 6, wherein the base station is configured to determine at least one of a location and a distance of one of the at least one mobile device to the base station based on signal strength of BLE signals received from the one of the at least one mobile device.

10. The system of claim 1, wherein the base station further includes a near-field communication (NFC) module to communicate with a NFC enabled device to prohibit charging the at least one mobile device in response to the NFC enabled device communicating with the NFC module of the base station.

11. A system comprising:
a base station for wirelessly charging at least one mobile device, the base station including a plurality of charging coils, a Bluetooth Low Energy (BLE) communication module, and a control module configured to:
communicate with the at least one mobile device via the BLE communication module to receive information about the at least one mobile device;
select at least one charging coil from the plurality of charging coils based on the received information about the at least one mobile device; and
activate the at least one charging coil to charge the at least one mobile device.

12. The system of claim 11, wherein the control module is further configured to receive information about at least one battery of the at least one mobile device via communication with the at least one mobile device and to output the information about the at least one battery of the at least one mobile device.

13. The system of claim 12, wherein the base station is located in a vehicle and the base station is configured to output the information about the at least one battery of the at least one mobile device to a display screen of the vehicle.

14. The system of claim 12, wherein the information about the at least one battery of the at least one mobile device includes at least one of a low battery status and a last time the battery was charged.

15. A method comprising:
activating, with a control module of a base station for wirelessly charging at least one mobile device, at least one first charging coil of a plurality of charging coils of the base station to charge the at least one mobile device during a first time period;
monitoring, with the control module, at least one electrical characteristic of the at least one first charging coil while charging the at least one mobile device during the first time period;
activating, with the control module, at least one second charging coil of the plurality of charging coils to charge the at least one mobile device during a second time period;
monitoring, with the control module, the at least one electrical characteristic of the at least one second charging coil while charging the at least one mobile device during the second time period;
comparing, with the control module, the at least one electrical characteristic monitored during the first time period with the at least one electrical characteristic monitored during the second time period; and
selecting, with the control module, one of the at least one first charging coil and the at least one second charging coil for charging the at least one mobile device during a third time period after the first and second time periods based on the comparison.

16. The method of claim 15, wherein the at least one mobile device includes a key fob.

17. The method of claim 15, wherein the at least one mobile device includes at least one of a smartphone and a smartwatch.

18. The method of claim 15, wherein the base station is configured to simultaneously charge a key fob and at least one of a smartphone and a smartwatch.

19. The method of claim 15, wherein the base station is configured to simultaneously charge each of a smartphone and a smartwatch.

20. The method of claim 15, wherein the base station further including a Bluetooth Low Energy (BLE) module to communicate with the at least one mobile device using BLE to receive information about at least one battery of the at least one mobile device and to output the information about the at least one battery of the at least one mobile device.

21. The method of claim 20, wherein the base station is located in a vehicle and the base station is configured to output the information about the at least one battery of the at least one mobile device to a display screen of the vehicle.

22. The method of claim 20, wherein the information about the at least one battery of the at least one mobile device includes at least one of a low battery status and a last time the battery was charged.

23. The method of claim 15, further comprising determining at least one of a location and a distance of the one of the at least one mobile device to the base station based on signal strength of BLE signals received from the one of the at least one mobile device.

24. The method of claim 15, wherein the base station further includes a near-field communication (NFC) module to communicate with a NFC enabled device to prohibit charging the at least one mobile device in response to the NFC enabled device communicating with the NFC module of the base station.

25. A method comprising:
communicating, using a Bluetooth Low Energy (BLE) communication module of a base station, with at least one mobile device to receive information about the at least one mobile device, the base station including a plurality of charging coils and a control module;
selecting, with the control module, at least one charging coil from the plurality of charging coils based on the received information about the at least one mobile device; and
activating, with the control module, the at least one charging coil to charge the at least one mobile device.

26. The method of claim 25, wherein the control module is further configured to receive information about at least one battery of the at least one mobile device via communication with the at least one mobile device and to output the information about the at least one battery of the at least one mobile device.

27. The method of claim 26, wherein the base station is located in a vehicle and the base station is configured to output the information about the at least one battery of the at least one mobile device to a display screen of the vehicle.

28. The method of claim 27, wherein the information about the at least one battery of the at least one mobile device includes at least one of a low battery status and a last time the battery was charged.
